(19) United States
(12) Patent Application Publication
(10) Pub. No.: US 2014/0230998 A1
(43) Pub. Date: Aug. 21, 2014

(54) PRESSURE-SENSITIVE ADHESIVE LABEL, METHOD OF MANUFACTURING PRESSURE-SENSITIVE ADHESIVE LABEL, AND LABEL ISSUING DEVICE

(71) Applicant: Seiko Instruments Inc., Chiba-shi (JP)

(72) Inventors: Kazuo TANI, Chiba-shi (JP); Yoshinori SATO, Chiba-shi (JP); Koichi HATAKEYAMA, Chiba-shi (JP)

(73) Assignee: Seiko Instruments Inc., Chiba-shi (JP)

(21) Appl. No.: 14/182,069

(22) Filed: Feb. 17, 2014

(30) Foreign Application Priority Data
Feb. 19, 2013 (JP) 2013-030305

(51) Int. Cl. G09F 3/10; B32B 38/10; B32B 38/00; B41M 5/30

(52) U.S. Cl. CPC G09F 3/10; B41M 5/30; B32B 38/10; B32B 38/145
USPC 156/235; 428/40.1; 428/41.3; 428/41.8; 503/200; 156/540; 156/499; 156/387

(57) ABSTRACT

A pressure-sensitive adhesive label comprising: recording paper including a recording surface; a pressure-sensitive adhesive layer placed on a rear surface of the recording paper on an opposite side of the recording surface; and a function layer placed on the pressure-sensitive adhesive layer, wherein a surface of the pressure-sensitive adhesive layer on the function layer side has a smoother surface than the rear surface of the recording paper, and the function layer is configured to be opened by heating to expose the pressure-sensitive adhesive layer.

### RELATED APPLICATIONS

This application claims priority under 35 U.S.C. §119 to Japanese Patent Application No. 2013-030305 filed on Feb. 19, 2013, the entire content of which is hereby incorporated by reference.

### BACKGROUND OF THE INVENTION

1. Field of the Invention

The present invention relates to a pressure-sensitive adhesive label that has non-pressure-sensitive adhesiveness at a time of storage and is allowed to express pressure-sensitive adhesiveness at a time of use.

2. Description of the Related Art

In recent years, pressure-sensitive adhesive labels have been used for a price indication label, a product indication label, an advertisement label, a seal label for a package, and the like. The pressure-sensitive adhesive label includes: a base containing an indication recording layer; a pressure-sensitive adhesive layer; and release paper (separator). When the pressure-sensitive adhesive label is adhered to an adherend, the release paper is peeled, and the pressure-sensitive adhesive label is adhered to the adherend via the exposed pressure-sensitive adhesive layer. A typical pressure-sensitive adhesive label is formed as follows. Band-shaped release paper is adhered onto a pressure-sensitive adhesive layer formed by coating the entire rear surface of a band-shaped base with a pressure-sensitive adhesive, and the resultant pressure-sensitive adhesive layer is stamped out. Therefore, when the release paper is peeled to adhere the pressure-sensitive adhesive label onto an adherend, the pressure-sensitive adhesive label is adhered onto the adherend over the entire rear surface of the pressure-sensitive adhesive label. Further, the release paper peeled off at a time of using the pressure-sensitive adhesive label is discarded without being re-used. Therefore, an environmental load cannot be reduced.

Hitherto, there has been used a pressure-sensitive adhesive label that includes a thermosensitive recording layer on a front surface of the base as the indication recording layer. This type of pressure-sensitive adhesive label records information by causing the thermosensitive recording layer to develop color with use of heating means, such as a thermal head. Specifically, the pressure-sensitive adhesive label has a laminate structure in which the thermosensitive recording layer obtained by mixing a color former and a developer is placed on the front surface of the base, a pressure-sensitive adhesive layer is placed on a rear surface of the base, and release paper is placed on a front surface of the pressure-sensitive adhesive layer. A surface of the release paper to be brought into contact with the pressure-sensitive adhesive layer is coated with a silicone resin to improve release properties of the release paper. In order to avoid unintended discoloring of the thermosensitive recording layer caused by heat in the manufacturing, the pressure-sensitive adhesive label is generally formed as follows. A pressure-sensitive adhesive is coated onto the release paper alone and dried to form the pressure-sensitive adhesive layer, and then the base and the release paper are laminated and integrated together through the intermediation of the pressure-sensitive adhesive layer. This prevents unintended color development or discoloring of the thermosensitive recording layer provided on the front surface of the base caused by the coated pressure-sensitive adhesive or by heat during drying.

On the other hand, there has been known a pressure-sensitive adhesive label that does not use release paper in order to reduce an environmental load. In this type of pressure-sensitive adhesive label, the thermosensitive recording layer is formed on the front surface of the base while the pressure-sensitive adhesive layer is placed on the rear surface of the base, and a release agent such as a silicone resin is coated onto a front surface of the thermosensitive recording layer (that is, the uppermost surface of the pressure-sensitive adhesive label). In this manner, even when the pressure-sensitive adhesive label is rolled into a roll, the release properties between the thermosensitive recording layer and the pressure-sensitive adhesive layer are secured.

As a method of manufacturing the above-mentioned related-art pressure-sensitive adhesive label, for example, Japanese Patent Application Laid-open No. Hei 5-8541 discloses a label thermosensitive recording material and a manufacturing method therefor, which require no release paper and prevent a reduction in sensitivity of the thermosensitive recording layer or unintended color development or discoloring thereof when the label thermosensitive recording material (pressure-sensitive adhesive label) is rolled into a roll. Specifically, a release layer instead of release paper is provided on the thermosensitive recording layer formed on the base. However, when a solvent-based release agent is used as the release layer, the thermosensitive recording layer is reduced in sensitivity or develops color unintendedly by the solvent. Further, when an emulsion-based release agent is used as the release layer, although the above-mentioned problem of the solvent is solved, a problem arises in that a release component may penetrate into the thermosensitive recording layer to reduce the recording sensitivity or the release component may shift to the pressure-sensitive adhesive layer. To deal with this, a non-solvent-based silicone resin is coated onto the thermosensitive recording layer so that a silicone resin layer is formed by being cured through irradiation of radiation such as ultraviolet light, and the resultant layer is used as the release layer. In this manner, the reduction in sensitivity and the unintended color development of the thermosensitive recording layer can be prevented.

Further, Japanese Patent Application Laid-open No. Hei 10-171355 discloses a mountless label (pressure-sensitive adhesive label that uses no release paper) and a manufacturing method therefor. In the case where an ultraviolet-curable silicone resin layer is used as a release layer formed on a thermosensitive color developing layer, if an elapsed period before use is long, a part of a pressure-sensitive adhesive shifts to the release layer to reduce release properties. As a result, the pressure-sensitive adhesive surface and the ultraviolet-curable silicone resin surface are adhered together, and it becomes difficult to unroll the rolled mountless label. In addition, the pressure-sensitive adhesive shifts to the thermosensitive color developing layer to hinder the transfer of heat of a thermal head to the thermosensitive color developing layer, and it becomes difficult to develop color. To deal with this, a solventless silicone resin is used as the release layer. Specifically, a solventless silicone layer is coated onto a front surface of a label base provided with a thermosensitive color developing layer, and is dried. Next, a pressure-sensitive adhesive is coated onto a rear surface of the label base, and is dried to form a mountless label. In this manner, the mountless label can be unrolled from a roll without reducing the release properties, and the thermosensitive color developing layer can be caused to develop color clearly.

In addition, Japanese Patent Application Laid-open No. 2004-1287 discloses a non-separator type thermosensitive recording label (pressure-sensitive adhesive label that uses no release paper) and a manufacturing method therefor. In the non-separator type thermosensitive recording label, a thermosensitive color developing layer is provided on one surface of a base and a release layer is laminated thereon, while an adhesive layer is provided on the other surface of the base. In this case, in the release layer, an additive is dispersed in a release agent matrix made of an emulsion-based silicone resin, and the release agent matrix is heated and cured in the presence of a curing catalyst such as organotin or a platinum catalyst. In this manner, smooth contact between a thermal head and a front surface of the release layer is obtained, and the thermal head moves smoothly to improve matching properties of the release layer with respect to the thermal head.

The above-mentioned related-art pressure-sensitive adhesive labels are configured so that the entire surface of the adhesive layer is adhered onto an adherend. However, depending on the application, instead of adhering the pressure-sensitive adhesive label onto an adherend over the entire rear surface thereof, it may be necessary to adhere the pressure-sensitive adhesive label onto an adherend in a state in which the pressure-sensitive adhesive force of the pressure-sensitive adhesive label is partially inhibited.

As this type of pressure-sensitive adhesive label, for example, Japanese Patent Application Laid-open No. 2012-63616 proposes, for improvement of the hitherto used pressure-sensitive adhesive label, a pressure-sensitive adhesive label that is allowed to express pressure-sensitive adhesiveness only in a necessary part without using any release paper. FIG. 8 illustrates a schematic cross-sectional view of a pressure-sensitive adhesive label 100 of this type (FIG. 1 of Japanese Patent Application Laid-open No. 2012-63616). The pressure-sensitive adhesive label 100 includes a support member 102, a pressure-sensitive adhesive layer 103 having pressure-sensitive adhesiveness that is formed on one surface of the support member 102, a low pressure-sensitive adhesive layer 105 formed on a surface of the pressure-sensitive adhesive layer 103, a thermal reactive layer (function layer) 104 that is formed on a surface of the low pressure-sensitive adhesive layer 105 and is opened by heating, and a printing layer 106 that is formed on the other surface of the support member 102 and records a character or graphic thereon. The pressure-sensitive adhesive label 100 expresses pressure-sensitive adhesiveness in a manner that the function layer 104 is heated and opened by heating means such as a thermal head to expose the underlying low pressure-sensitive adhesive layer 105 or the underlying pressure-sensitive adhesive layer 103. Therefore, the region to express pressure-sensitive adhesiveness can be arbitrarily set depending on the application of the pressure-sensitive adhesive label 100 or the properties of an adherend. Further, the pressure-sensitive adhesive label 100 has an advantage that an environmental load can be reduced because no release paper is necessary.

The above-mentioned pressure-sensitive adhesive labels disclosed in Japanese Patent Application Laid-open Nos. Hei 5-8541, Hei 10-171355, and 2004-1287 do not use any release paper, and hence the environmental load can be reduced. However, instead of providing the release paper, it is necessary to provide the release layer directly on the front surface of the thermosensitive recording layer, and hence the recording sensitivity of the thermosensitive recording layer is reduced because of its structure. Further, because the release layer is provided directly on the thermosensitive recording layer, it is necessary to use an ultraviolet-curable silicone resin or the like as the release layer. The ultraviolet-curable silicone resin has problems of being expensive and being difficult to thin the release layer. In addition, the ultraviolet-curable silicone resin tends to generate heat during curing, and there is a limitation on application conditions, and hence an additional novel manufacturing device is necessary. In other words, as a lamp for ultraviolet curing, an ozoneless lamp that generates less ozone, such as a low-pressure mercury lamp, a medium-pressure mercury lamp, a high-pressure mercury lamp, and a metal halide lamp needs to be selected, and a manufacturing device in which a plurality of high power lamps of power of 30 W/cm or more are arranged is necessary.

The pressure-sensitive adhesive label 100 disclosed in Japanese Patent Application Laid-open No. 2012-63616 is useful in that the environmental load can be reduced because no release paper is used and that the region to express the adhesiveness can be arbitrarily set. However, in the case where paper or the like is used as the support member 102 and a thermosensitive recording layer containing a color former and a developer is used as the printing layer 106, it is necessary to manufacture the pressure-sensitive adhesive label so that the thermosensitive recording layer may not be affected by heat. According to the related-art method of manufacturing the pressure-sensitive adhesive label having release paper, the pressure-sensitive adhesive is coated onto the release paper and is adhered onto the support member after drying. However, the function layer 104 of the pressure-sensitive adhesive label 100 is thin and low in strength. Accordingly, it is difficult to coat the pressure-sensitive adhesive onto the function layer 104 and dried for conveyance or to adhere the resultant onto the support member 102 as performed in the related-art method. In addition, the tension of the thermal reactive layer 104 in the flow direction or the width direction needs to be maintained in a given range during the manufacturing process, and further the flatness of the surface needs to be secured. Accordingly, unlike the related art, the thermal reactive layer 104 cannot be used as an alternative to the release paper.

On the other hand, in the case where the pressure-sensitive adhesive label 100 disclosed in Japanese Patent Application Laid-open No. 2012-63616 is manufactured by employing the above-mentioned method disclosed in Japanese Patent Application No. Hei 5-8541, Hei 10-171355, or 2004-1287, it is necessary to form the pressure-sensitive adhesive layer 103 by coating a pressure-sensitive adhesive directly onto the support member 102. However, when the pressure-sensitive adhesive is coated directly onto the support member 102, a solvent volatilizes from the pressure-sensitive adhesive, and the printing layer 106 formed on the opposite surface of the support member 102 develops color or becomes discolored unintendedly. To prevent this, it is conceivable to increase the thickness of the support member 102 so that a solvent contained in the pressure-sensitive adhesive may be dried and evaporated before the solvent of the pressure-sensitive adhesive penetrates to the thermosensitive recording layer side of the support member 102. However, the pressure-sensitive adhesive label 100 itself becomes thicker and bulky, and the drying step for completely evaporating the solvent of the pressure-sensitive adhesive becomes longer. Consequently, the thermosensitive recording layer develops color or becomes discolored unintendedly by heat during the drying step.

From the foregoing, in this technical field, demands have been made for a pressure-sensitive adhesive label, a manufacturing method therefor, and a pressure-sensitive adhesive label manufacturing device that are capable of avoiding a thermosensitive recording layer from developing color or becoming discolored by heat or a solvent during a manufacturing process.

### SUMMARY OF THE INVENTION

A pressure-sensitive adhesive label according to one embodiment of the present invention includes: recording paper including a recording surface; a pressure-sensitive adhesive layer placed on a rear surface of the recording paper on an opposite side of the recording surface; and a function layer placed on the pressure-sensitive adhesive layer, in which a surface of the pressure-sensitive adhesive layer on the function layer side has a smoother surface than the rear surface of the recording paper, and the function layer is configured to be opened by heating to expose the pressure-sensitive adhesive layer.

Further, the surface of the pressure-sensitive adhesive layer on the function layer side has a surface roughness in a range of from 0.3 μm to 1.2 μm.

Further, the function layer has an average layer thickness in a range of from 0.1 μm to 10 μm.

Further, the function layer is formed of an olefin-based resin.

Further, the function layer is formed of a porous layer.

Further, the porous layer has a void content in a range of from 30% to 85%.

Further, the function layer is formed by laminating a first thermoplastic resin and a second thermoplastic resin, which are incompatible to each other.

Further, an opening formed by heating the function layer has a diameter of 40 μm or more.

Further, a release layer is placed on the function layer.

Further, the recording paper includes, at least on the recording surface, a thermosensitive recording layer on which recording is performed by heating.

A method of manufacturing a pressure-sensitive adhesive label according to one embodiment of the present invention includes: coating a smooth surface of a support member with a pressure-sensitive adhesive; drying the pressure-sensitive adhesive to form a pressure-sensitive adhesive layer; transferring the pressure-sensitive adhesive layer onto a rear surface of recording paper on an opposite side of a recording surface thereof, and finishing a surface of the pressure-sensitive adhesive layer to a smoother surface than the rear surface of the recording paper; and adhering a function layer onto the pressure-sensitive adhesive layer.

Further, the support member is formed of an endless belt having a smooth surface.

A pressure-sensitive adhesive label manufacturing device according to one embodiment of the present invention includes: pressure-sensitive adhesive coating means for coating a surface of a support member with a pressure-sensitive adhesive; pressure-sensitive adhesive drying means for drying the coated pressure-sensitive adhesive to form a pressure-sensitive adhesive layer; pressure-sensitive adhesive layer transferring means for transferring the pressure-sensitive adhesive layer onto recording paper; and function layer adhering means for adhering a function layer onto the pressure-sensitive adhesive layer.

Further, the support member is formed of an endless belt having a smooth surface.

A label issuing device according to one embodiment of the present invention includes: a conveying part for conveying the pressure-sensitive adhesive label; a heating part for heating the function layer to form an opening to expose the pressure-sensitive adhesive layer; and a control part for controlling the conveying part and the heating part.

Further, recording is performed by heating the recording surface of the pressure-sensitive adhesive label.

A pressure-sensitive adhesive label according to one embodiment of the present invention includes: recording paper including a recording surface; a pressure-sensitive adhesive layer placed on the recording paper on an opposite side of the recording surface; and a function layer placed on the pressure-sensitive adhesive layer, the function layer being configured to be opened by heating to expose the pressure-sensitive adhesive layer. Then, before the pressure-sensitive adhesive layer is adhered onto the recording paper, the pressure-sensitive adhesive layer is sufficiently dried. After a solvent is volatilized, the pressure-sensitive adhesive layer is adhered onto the recording paper. In this manner, the recording surface is prevented from developing color or becoming discolored.

### BRIEF DESCRIPTION OF THE DRAWINGS

FIG. 1 is a schematic cross-sectional view of a pressure-sensitive adhesive label according to a first embodiment of the present invention.

FIGS. 2A, 2B, and 2C are views illustrating how to express pressure-sensitive adhesiveness in the pressure-sensitive adhesive label according to the first embodiment of the present invention.

FIG. 3 is a schematic cross-sectional view of a pressure-sensitive adhesive label according to a second embodiment of the present invention.

FIG. 4 is a schematic cross-sectional view of a pressure-sensitive adhesive label according to a third embodiment of the present invention.

FIG. 5 is a schematic cross-sectional view of a pressure-sensitive adhesive label according to a fourth embodiment of the present invention.

FIG. 6 is a schematic cross-sectional view of a pressure-sensitive adhesive label according to a fifth embodiment of the present invention.

FIG. 7 is a flowchart illustrating a method of manufacturing a pressure-sensitive adhesive label according to a sixth embodiment of the present invention.

FIG. 8 is a schematic structural view of a pressure-sensitive adhesive label manufacturing device for manufacturing a pressure-sensitive adhesive label according to a seventh embodiment of the present invention.

FIG. 9 is a schematic structural view of a pressure-sensitive adhesive label manufacturing device for manufacturing a pressure-sensitive adhesive label according to an eighth embodiment of the present invention.

FIG. 10 is a schematic structural view of a label issuing device according to a ninth embodiment of the present invention.

FIG. 11 is a schematic structural view of a label issuing device according to a tenth embodiment of the present invention.

FIG. 12 is a schematic cross-sectional view of a related-art pressure-sensitive adhesive label.

### DETAILED DESCRIPTION OF THE PREFERRED EMBODIMENTS

A pressure-sensitive adhesive label 1 according to the present invention includes recording paper, a pressure-sensitive adhesive layer, and a function layer. When heated, the function layer is opened to expose the pressure-sensitive adhesive layer. A surface of the pressure-sensitive adhesive layer on the function layer side has a smoother surface than a rear surface of the recording paper.

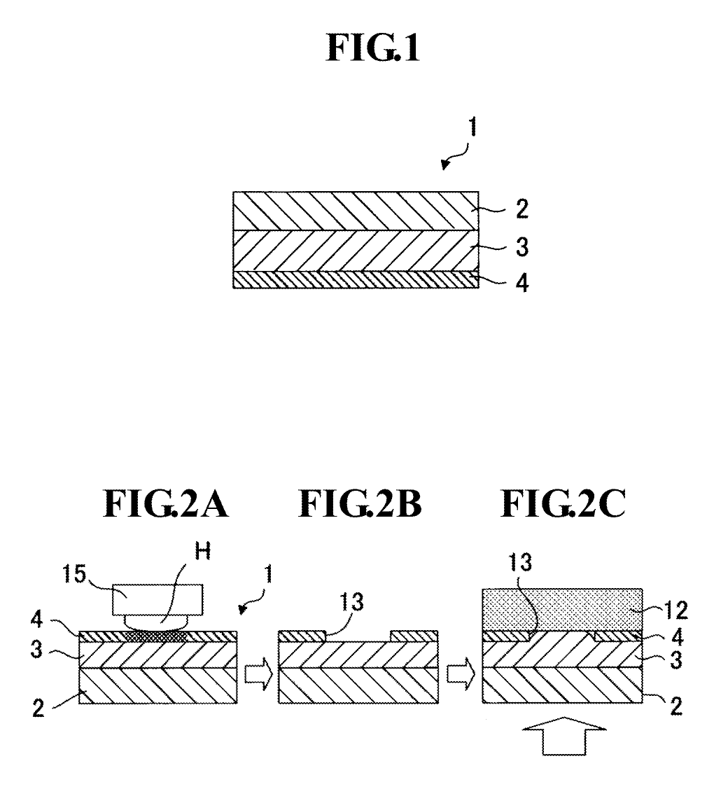

FIG. 1 is a schematic cross-sectional view of a pressure-sensitive adhesive label 1 according to a first embodiment of the present invention. As illustrated in FIG. 1, the pressure-sensitive adhesive label 1 has a laminate structure including recording paper 2, a pressure-sensitive adhesive layer 3, and a function layer 4. A surface of the recording paper 2 on the opposite side of the pressure-sensitive adhesive layer 3 serves as a recording surface, and a thermosensitive recording layer (not shown) is formed thereon. The pressure-sensitive adhesive layer 3 is placed on a rear surface of the recording paper 2 on the opposite side of the recording surface. The function layer 4 is placed on the pressure-sensitive adhesive layer 3. In this case, a surface of the pressure-sensitive adhesive layer 3 on the function layer 4 side has a smoother surface than the rear surface of the recording paper 2.

More specifically, the rear surface of the recording paper 2 on the opposite side of the recording surface has a smoothness (surface roughness) in the range of 1.2 μm or less, preferably in the range of from 0.3 μm to 1.2 μm, whereas the surface of the pressure-sensitive adhesive layer 3 on the function layer 4 side has a smoothness of 10 μm or more. The smoothness of the pressure-sensitive adhesive surface of the pressure-sensitive adhesive layer 3 is set to be higher than the smoothness of the surface of the recording paper 2 supporting the pressure-sensitive adhesive layer 3, to thereby increase a contact area of the pressure-sensitive adhesive layer 3 with respect to an adherend 12 and improve pressure-sensitive adhesive force.

FIGS. 2A to 2C are views illustrating how to express pressure-sensitive adhesiveness in the pressure-sensitive adhesive label 1 according to the first embodiment of the present invention. A thermal head 15 is used as heating means. As illustrated in FIG. 2A, a heating part H of the thermal head 15 is brought into contact with the function layer 4 of the pressure-sensitive adhesive label 1. Then, as illustrated in FIG. 2B, the heated function layer 4 is melted and shrinks, and an opening 13 is formed to expose the underlying pressure-sensitive adhesive layer 3. Next, as illustrated in FIG. 2C, when the pressure-sensitive adhesive label 1 is placed so that the opening 13 side is placed on an adherend 12 and relatively pressed from the recording paper 2 side, a pressure-sensitive adhesive contained in the pressure-sensitive adhesive layer 3 adheres to the adherend 12 through the opening 13. Accordingly, by selecting the number of the openings 13 and the positions thereof by the thermal head 15, the pressure-sensitive adhesiveness of the pressure-sensitive adhesive label 1 can be controlled depending on the properties of the adherend 12 and the application. In addition, no release paper is used, and hence an environmental load is reduced.

The recording paper 2 includes a base made of paper or the like and a thermosensitive recording layer provided on the surface of the base. In the thermosensitive recording layer, for example, a leuco dye is used as a color former, and such a compound or oxide that develops color by heat when brought into contact with the leuco dye is used as a developer. The recording surface of the recording paper 2 is the surface on the side where the above-mentioned thermosensitive recording layer is formed. Further, instead of forming the thermosensitive recording layer, a recording surface that records information by an inkjet method, an electrophotographic method, a laser printing method, or the like may be used. In this case, the surface of the based made of paper or the like can be used as the recording surface.

As illustrated in FIG. 2C, it is preferred that the base of the recording paper 2 be made of a material capable of enlarging a contact area between the pressure-sensitive adhesive layer 3 and the adherend 12 when pressure is applied from the recording paper 2 side. Further, it is preferred that the base of the recording paper 2 be made of a material capable of maintaining the contact area for a long period of time. When a material having large stiffness is used as the base, the pressure-sensitive adhesive layer 3 does not easily come into contact with the surface of the adherend 12 through the opening 13, and the pressure-sensitive adhesive layer 3 peels off from the surface of the adherend 12 due to the stiffness of the base after the contact, with the result that predetermined pressure-sensitive adhesive force cannot be maintained. Thus, one of paper and a polyolefin-based polymer having small stiffness is used as the base of the recording paper 2.

Examples of the paper to be used as the base of the recording paper 2 include glassine paper, high-quality paper, art paper, design paper, Japanese paper, a non-woven fabric, synthetic paper, recycled paper, coated paper, fine coated paper, cast coated paper, and paper board. It is preferred that the high-quality paper contain, as its main components, wooden pulp such as hardwood pulp (NBKP) and softwood pulp (LBKP), and a plant material such as straw, bagasse, and hemp, and be not coated with pigment coating. It is preferred that the high-quality paper be, of those which are classified as printing information sheets in “Grade Classification Table of Paper and Paper Board” (published by Japan Paper Association) described in “Paper and Paper Board Statistical Chronology”, those which are classified as non-coated printing sheets and those which correspond to business form paper, PPC sheets, and the like classified as information sheets. It is preferred that the recycled paper be, of those which are classified as the above-mentioned high-quality paper, those which use a recycled waste-paper material.

The art paper and the coated paper are those which are classified as coated printing sheets in the above-mentioned “Grade Classification Table of Paper and Paper Board” and include those which are classified as lightweight coated paper. The fine coated paper includes those which are classified as fine coated printing sheets 1 to 3 in the above-mentioned “Grade Classification Table of Paper and Paper Board”. The design paper includes fancy paper, embossed paper, and the like classified as special printing sheets and other coating printing sheets.

The cast coated paper is cast coated paper classified as other printing sheets in the above-mentioned “Grade Classification Table of Paper and Paper Board”, and is excellent in smoothness and used for advanced printing applications. The paper boards are those which are classified as cardboard base paper and packaging paper board in the above-mentioned “Grade Classification Table of Paper and Paper Board”. The Japanese paper includes not only hand-made paper using a plant material such as paper mulberry and Edgeworthia chrysantha but also paper machine Japanese paper and the like imitating the hand-made paper. The non-woven fabric includes those which are formed into a sheet shape without using water as well. The synthetic papers are those which are formed into a sheet shape by subjecting a synthetic resin material to axial stretching or the like.

Which of the above-mentioned materials is used as the base of the recording paper 2 is determined considering label applications and indication recording contents. For example, in the case where the pressure-sensitive adhesive label 1 is used for adhesion to various food wrapping labels, catalogues, posters, and the like, coated paper such as coated paper, art paper, and cast coated paper is preferred as the base. Further, in the case where the pressure-sensitive adhesive label 1 is used for special labels, design paper, a non-woven fabric, a synthetic paper, a paper board, or the like is suitable as the base. Further, in the case of mainly printing characters or bar codes on the recording surface of the recording paper 2, fine coated paper and high-quality paper are preferred as the base.

As the base of the recording paper 2, a polyolefin-based polymer can be used. The polyolefin-based polymer uses a resin derived from a plant excellent in environment suitability, and has low-temperature shrinking properties, soft body, a small natural shrinkage ratio, excellent rupture resistance, stiffness, and shrinking finish properties, and characteristics for suppressing natural shrinking and inter-layer peeling. Note that, these examples are merely given for illustrative purposes, and any material can be used as the base of the recording paper 2 as long as pressure-sensitive adhesive force can be easily expressed. That is, the base of the recording paper 2 only needs to be appropriately adjusted depending on the application.

As the pressure-sensitive adhesive layer 3, a pressure-sensitive adhesive can be used. The pressure-sensitive adhesive can express adhesiveness simply by the application of a small pressure at room temperature without applying water, solvent, heat, or the like. In addition, the pressure-sensitive adhesive has cohesive force with elasticity and expresses high adhesiveness, and can be peeled off even from a hard smooth surface. Specifically, a silicone-based pressure-sensitive adhesive, a rubber-based pressure-sensitive adhesive, and an acrylic pressure-sensitive adhesive can be used depending on the application. The silicone-based pressure-sensitive adhesive includes silicone having high cohesive force or silicone having high pressure-sensitive adhesive force. The rubber-based pressure-sensitive adhesive includes natural rubber, styrene-butadiene rubber (SBR), polyisobutylene, and other such rubber-based materials. The acrylic pressure-sensitive adhesive includes a cross-linked material using monomers having a low glass transition point and a cross-linking material, and a non-cross-linked material obtained by co-polymerizing a monomer having a low glass transition point and a monomer having a high glass transition point.

Available solvents for forming the pressure-sensitive adhesive layer 3 include an emulsion type and an organic solvent type. In the case of using the organic solvent type, the boiling point of an organic solvent can be set as temperature in drying. For example, in the case where toluene is used as an organic solvent, temperature in drying is set to 70° C. In the case of using an ethyl acetate-based organic solvent, temperature in drying is set to 75° C. In the case of using the emulsion-based solvent, temperature in drying is set to 100° C. In the case of using the organic solvent type, the temperature, the conveyance speed, and the air volume can be adjusted in the drying process after the application of the pressure-sensitive adhesive. In a one-organic solvent system and a two-organic solvent system, the temperature in the drying process may be set to be equal to or lower than the boiling point and the air volume and the like may be adjusted. Considering the color developing temperature of the thermosensitive recording layer, it is preferred to use toluene as a solvent.

It is preferred that the function layer 4 be made of a material with good controllability and capable of forming the opening 13 to have a predetermined opening diameter when the function layer 4 is applied with heat. As the function layer 4, an olefin-based resin or an engineering plastic can be used. The olefin-based resin is used for many purposes as a general-purpose resin, and hence, can form the function layer 4 at low cost. As the olefin-based resin, for example, polyethylene (PE), polyvinyl chloride (PVC), polypropylene (PP), a multi-layer polyolefin-based resin in which PE and PP are stacked, polystyrene (PS), polyester, polyethylene terephthalate (PET), a copolymer of ethylene terephthalate and ethylene isophthalate, and a copolymer of hexamethylene terephthalate and cyclohexanedimethylene terephthalate can be used. In order to improve opening sensitivity, for example, a copolymer of ethylene terephthalate and ethylene isophthalate, and a copolymer of hexamethylene terephthalate and cyclohexanedimethylene terephthalate are particularly preferred.

As the olefin-based resin, for example, a homopolymer, a copolymer, or a multistage polymer can be used. Polyolefins selected from the group consisting of the homopolymer, the copolymer, and the multistage polymer can each be used alone, or can be used as a mixture. Typical examples of the above-mentioned polymers include low-density polyethylene, linear low-density polyethylene, medium-density polyethylene, high-density polyethylene, ultrahigh molecular weight polyethylene, isotactic polypropylene, atactic polypropylene, polybutene, and ethylene propylene rubber.

Further, as the function layer 4, a hybrid that is a stack type of PS and PET, an ethylene/vinyl acetate copolymer (EVA)-based resin, a polyvinyl alcohol (PVA)-based resin, a polylactic acid (PLA)-based resin that is a plant-based material, and the like can be used. Further, a cellulose-based material that can be expected to lower the cost can be used. It is preferred to select a material whose contact angle with the pressure-sensitive adhesive layer 3 to be adjacent to the function layer 4 increases during heating. Further, a uniaxially stretched or biaxially stretched material which uses a stretching process can be used for forming the function layer 4. In the case of using a stretched film, there can be used a material which is stabilized chemically and mechanically by manipulating a glass transition point by copolymerizing a single monomer with another monomer or blending different kinds of components such as rubber. Co-stretching may be uniaxial stretching or biaxial stretching, but biaxial stretching is preferred in terms of orientation, uniform dispersibility, molecule arrangement, or mechanical strength of the film. Biaxial stretching may be sequential biaxial stretching or simultaneous biaxial stretching. In the case of biaxial stretching, in general, the material is stretched in the vertical direction and in the horizontal direction in this order, but may be stretched in the reverse order. The stretch ratio is not particularly limited, but is determined depending on, for example, the sensitivity required for the material or film to be used. Appropriate vertical and horizontal stretch ratios are preferably 2 to 10, more preferably 3 to 8. Further, after the biaxial stretching is performed, the material may be again stretched in the vertical or horizontal direction or in the vertical and horizontal directions. As the function layer 4 is formed thinner, the function layer 4 has a smaller heat capacity and a higher sensitivity.

The viscosity average molecular weight of the olefin-based resin is preferably 50,000 to 12,000,000, more preferably 50,000 to less than 2,000,000, most preferably 100,000 to less than 1,000,000. If the viscosity average molecular weight is 50,000 or more, the melt-tension at a time of melt molding becomes large to enhance moldability, which provides sufficient entanglement and tends to give high strength. If the viscosity average molecular weight is 12,000,000 or less, particularly, thickness stability is excellent.

Note that, it is preferred that the function layer 4 have a small heat capacity. More specifically, in the case where the heat capacity of the function layer 4 is smaller than that of the pressure-sensitive adhesive layer 3, when the function layer 4 is heated, the rise in temperature and melting of the function layer 4 are facilitated, and the pressure-sensitive adhesive layer 3 can be prevented from being deformed or denatured due to heat. In this case, it is desired that the average thickness of the function layer 4 be 0.1 μm to 10 μm. When the thickness of the function layer 4 is less than 0.1 μm, the coating property of the pressure-sensitive adhesive layer 3 is reduced. When the thickness of the function layer 4 is more than 10 μm, the heat conductivity is reduced and the opening diameter of the opening is decreased. In the case where a polyester film is used as the function layer 4, the thickness is preferably set to be 0.1 μm to 5 μm. When the thickness is 5 μm or less, the opening property is excellent. When the thickness is 0.1 μm or more, the film can be stably formed. Further, the melting point of the function layer 4 is set in the range of from 50° C. to 280° C., preferably in the range of from 220° C. to 250° C. This improves the controllability of the opening shape. Further, the grass transition point of the function layer 4 is set to be room temperature or higher. This facilitates the handling of the pressure-sensitive adhesive label 1.

Further, the pressure-sensitive adhesive layer 3 to be exposed through the opening 13 needs to be brought into and maintained in contact with the adherend 12. Therefore, the diameter of the opening 13 is set to be 40 μm or more. When the diameter of the opening 13 is less than 40 μm, the pressure-sensitive adhesive force between the pressure-sensitive adhesive layer 3 and the adherend 12 is reduced, which is unsuitable for practical use. It is preferred that the thickness of the pressure-sensitive adhesive layer 3 be set to be 20 μm to 300 μm. When the pressure-sensitive adhesive layer 3 is formed to have a thickness of less than 20 μm, the pressure-sensitive adhesive layer 3 does not easily come into contact with the surface of the adherend 12 through the opening 13, and sufficient adhesive force cannot be ensured. When the thickness of the pressure-sensitive adhesive layer 3 is set to be more than 300 μm, it is difficult to form the pressure-sensitive adhesive layer 3 itself.

Further, it is preferred that the pressure-sensitive adhesive force with respect to the adherend 12 be set to be 0.3 N/(50 mm width) to 20 N/(50 mm width). Note that, the pressure-sensitive adhesive force of 0.3 N/(50 mm width) means the following: when the pressure-sensitive adhesive label 1 with a width of 50 mm is adhered to the adherend 12 such as a stainless steel plate, and one end thereof is bent by 180° and pulled toward the other end, a force of 0.3 N is required for peeling off the pressure-sensitive adhesive label 1 from the adherend 12 (defined by JIS Z0237-2001). In the case where the pressure-sensitive adhesive force is smaller than 0.3 N/(50 mm width), the pressure-sensitive adhesive force is small, and in the case where the pressure-sensitive adhesive force is more than 20 N/(50 mm width), the pressure-sensitive adhesive label 1 does not peel off easily from the adherend 12. Both the cases are not practical.

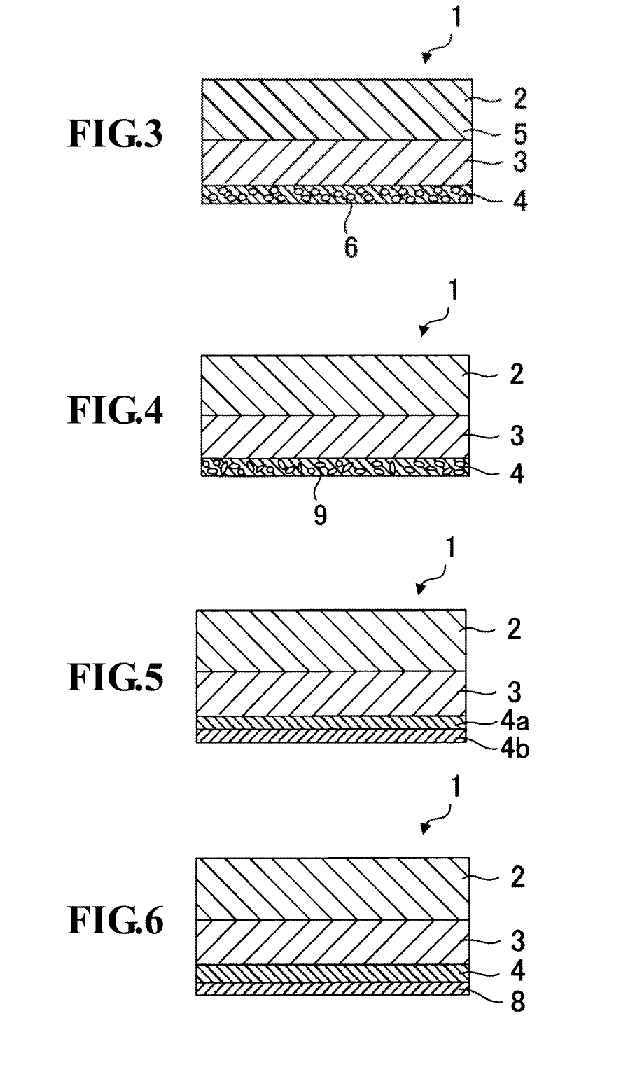

FIG. 3 is a schematic cross-sectional view of a pressure-sensitive adhesive label 1 according to a second embodiment of the present invention. The second embodiment is different from the first embodiment in that the function layer 4 contains an inorganic filler 6, but is the same as the first embodiment in the other configurations. Therefore, the different point is mainly described below. Like reference symbols denote like parts or parts having like functions.

The pressure-sensitive adhesive label 1 has a structure in which the recording paper 2, the pressure-sensitive adhesive layer 3, and the function layer 4 are laminated in this order, and the inorganic filler 6 is contained in the function layer 4 in a dispersed manner. The inorganic filler 6 is formed from an inorganic material. The inorganic material is higher in heat conductivity than a resin material. For example, the heat conductivity of a polymer material is 0.1 W/(m° C.) to 0.5 W/(m° C.), but the heat conductivity of an inorganic material is higher than that by one or more orders of magnitude. Consequently, the heat conductivity of the function layer 4 can be improved, and the temperature of the heating region of the function layer 4 can be quickly raised over the entire thickness. With this, the function layer 4 can be stably opened with high sensitivity, and the position and area of the exposed region of the pressure-sensitive adhesive layer 3 can be controlled with high accuracy. Further, due to the thickness of the opened function layer 4 itself or due to the fact that the periphery of the opening 13 is formed higher than the surface of the function layer 4, the heating part and the pressure-sensitive adhesive layer 3 can be prevented from being brought into direct contact with each other, and the paper feeding performance of the pressure-sensitive adhesive label 1 can be ensured. Further, the pressure-sensitive adhesive layer 3 acts to suppress the increase in diameter of the opening of the function layer 4 because of its pressure-sensitive adhesive force, but the pressure-sensitive adhesive force is reduced along with the increase in temperature of the pressure-sensitive adhesive layer 3. In other words, by dispersing the inorganic filler 6 in the function layer 4 to increase the heat conductivity, the temperature unevenness of the function layer 4 is reduced, and the pressure-sensitive adhesive layer 3 is also heated and the pressure-sensitive adhesive function is reduced, with the result that the force of suppressing the increase in diameter of the opening of the function layer 4 is reduced. In this manner, the openings 13 can be more easily formed in the function layer 4.

The function layer 4 contains the inorganic filler 6 at 10 vol % to 90 vol %. When the content ratio is less than 10 vol %, the effect of improving the heat conductivity is low. When the content ratio is more than 90 vol %, the fluctuations in physical property value are large. Note that, the inorganic filler 6 is covered by a resin material, and hence the heat conductivity of the resin material is dominant so that the heat conductivity based on a proportional relationship between the resin material and the inorganic material is not expressed. The function layer 4 contains the inorganic filler 6 preferably at 20 vol % to 60 vol %. If necessary, the function layer 4 may be added with a material for adjusting the physical property value, such as a plasticizer. The shape of the inorganic filler 6 may be plate-like or spherical. Although not particularly limited, it is more preferred that the inorganic filler 6 have a spherical particle shape rather than a nonspherical particle shape in consideration of the fluctuations in physical property value and the dispersibility.

The kind of the inorganic filler 6 is not particularly limited. As the filler, there may be used one, or a mixture of two or more, of, for example: oxide-based ceramics of alumina, silica, titania, zirconia, magnesia, yttria, zinc oxide, iron oxide, and the like; nitride-based ceramics of silicon nitride, titanium nitride, boron nitride, and the like; ceramics of silicon carbide, calcium carbonate, aluminum sulfate, aluminum hydroxide, potassium titanate, talc, kaolin clay, kaolinite, halloysite, pyrophyllite, montmorillonite, sericite, mica, amesite, bentonite, asbestos, zeolite, calcium silicate, magnesium silicate, diatomaceous earth, silica sand, and the like; and a glass fiber. For example, the boron nitride filler, the silicon carbide filler, and the aluminum nitride filler have heat conductivity that is 5 to 40 times as high as oxide fillers. Further, by adding an oxide filler such as alumina or silica for a resin material, the heat conductivity can be increased by one or more orders of magnitude. The other layer materials and configurations are the same as those in the first embodiment, and hence descriptions thereof are omitted.

FIG. 4 is a schematic cross-sectional view of a pressure-sensitive adhesive label 1 according to a third embodiment of the present invention. The third embodiment is different from the first embodiment in that the function layer 4 is a porous layer, but is the same as the first embodiment in the other configurations. Therefore, the different point is mainly described below. Like reference symbols denote like parts or parts having like functions.

The pressure-sensitive adhesive label 1 has a structure in which the recording paper 2, the pressure-sensitive adhesive layer 3, and the function layer 4 are laminated in this order, and the function layer 4 is formed of a porous layer including a large number of air pores 9 (hereinafter referred to as “porous function layer”). The porous function layer is smaller in heat capacity than a function layer made of a non-porous homogeneous material having a uniform thickness. Consequently, the porous function layer can be opened with lower heat energy as compared to a non-porous homogeneous material. By heating, the porous function layer melts to be opened by surface tension. In this case, the porous function layer is smaller in material density than the function layer made of the non-porous homogeneous material. Because a large number of pores are opened in the surface of the porous function layer, the contact area between the porous function layer and the pressure-sensitive adhesive layer 3 is reduced as compared to the non-porous homogeneous material. Thus, the pressure-sensitive adhesive function of the pressure-sensitive adhesive layer 3, which hinders the opening of the porous function layer, is reduced. Further, in the opened porous function layer, a convex part is formed at its periphery part in accordance with the volume of the melted porous material and the opening area. The porous function layer contains a large number of hollow regions inside, and hence no thermal diffusion occurs unlike the non-porous homogeneous material, that is, the thermal isolation is high and the heat is not easily diffused in a plane direction. Thus, the opening does not extend to a region other than the region with which the heating part H is brought into contact. As a result, the pressure-sensitive adhesive characteristics of the pressure-sensitive adhesive label 1 can be expressed with high sensitivity, and the position and shape of the openings 13 can be controlled with high accuracy.

The porous function layer has a cushion property unlike the non-porous homogeneous material. The cushion property of the porous function layer improves the adhesiveness with respect to the thermal head, thereby allowing heat of the heat generating part to be easily transferred to the porous function layer. Consequently, even in the case where the smoothness of the surface of the function layer 4 is poor, the opening sensitivity of the porous function layer can be improved, and desired pressure-sensitive adhesiveness can be expressed by accurately controlling the positions and shapes of the openings.

It is preferred that the porous function layer have a porosity of 30% to 85% and an average pore diameter of 0.01 μm to 10 μm. The thickness of the porous function layer can be set to be 0.1 μm to 50 μm, preferably 1 μm to 30 μm. Note that, it is preferred to set the average pore diameter of the porous function layer to be smaller than the thickness of the porous function layer so that no through hole may be formed. With this, the heat capacity of the porous function layer can be reduced so as to open the porous function layer with low heat energy. According to the pressure-sensitive adhesive label 1 of the present invention, the heating part H and the pressure-sensitive adhesive layer 3 are not easily brought into contact with each other because of the thickness of the opened porous function layer and the convex part formed at the periphery of the opening 13. Note that, although depending on the material characteristics of the porous layer, the temperature for opening the porous function layer by heating can be set to be about 100° C. to 200° C. In this manner, power saving of the device can be realized, and the sensitivity of the pressure-sensitive adhesive label can be enhanced.

When a synthetic resin material is used as the porous function layer, the heat capacity per unit area can be reduced to be smaller than that of the underlying pressure-sensitive adhesive layer 3. In other words, the heat capacity of the lower porous function layer becomes smaller than the heat capacity of the upper pressure-sensitive adhesive layer 3, and hence the rise in temperature of the upper pressure-sensitive adhesive layer 3 can be suppressed to prevent the pressure-sensitive adhesive layer 3 from being deformed or denatured due to heat.

The porous function layer can be formed by a stretching process, or by, for example, mixing and dispersing vaporizable particles in a material serving as a base and then vaporizing the particles. As the base, an olefin-based resin can be used, which has been described above in the first embodiment. The other layer materials and configurations are the same as those in the first embodiment, and hence descriptions thereof are omitted.

FIG. 5 is a schematic cross-sectional view of a pressure-sensitive adhesive label 1 according to a fourth embodiment of the present invention. The fourth embodiment is different from the first embodiment in that the function layer 4 is made up of a double-layered thermoplastic resin, but is the same as the first embodiment in the other configurations. Therefore, the different point is mainly described below. Like reference symbols denote like parts or parts having like functions.

As illustrated in FIG. 5, the function layer 4 has a structure in which a first thermoplastic resin 4a and a second thermoplastic resin 4b that are incompatible with each other are laminated. Those incompatible first thermoplastic resin 4a and second thermoplastic resin 4b are subjected to co-extrusion to form the function layer 4. The adhesive strength between layers of the first thermoplastic resin 4a and the second thermoplastic resin 4b can be set to be 0.05 g/cm to 5 g/cm, and the thickness fluctuations can be set to be 10% or less as whole. Further, the surface of the function layer 4 (second thermoplastic resin 4b) can be set to have a center-line average roughness (Ra) of 0.05 μm to 0.1 μm and a maximum roughness (Rmax) of 1.0 μm or less. As a result, the release properties and the slippage properties of the top surface (surface opposite to the pressure-sensitive adhesive layer 3) of the function layer 4 (second thermoplastic resin 4b), and of a release layer (see the fifth embodiment) if the release layer is placed on the top surface of the function layer 4 are further improved, and hence the pressure-sensitive adhesive label 1 can be easily pulled out of the roll to prevent the sticking between the pressure-sensitive adhesive label 1 and the heat generating part of the thermal head and the contamination of the device.

For example, as any one of the first and second thermoplastic resins 4a and 4b, polyester may be used, and as the other resin, polyolefin may be used. The polyester is a linear polyester formed of a dicarboxylic acid component and a glycol component, and examples of the dicarboxylic acid component may include terephthalic acid, isophthalic acid, phthalic acid, naphthalenedicarboxylic acid, diphenyldicarboxylic acid, and diphenyl ether dicarboxylic acid. In addition, examples of the glycol component may include ethylene glycol, 1,3-propylene glycol, 1,4-butanediol, 1,5-pentanediol, 1,6-hexanediol, 1,4-cyclohexanedimethanol, diethylene glycol, and neopentyl glycol. Preferred examples of the polyester include polyethylene terephthalate, polyethylene-2,6-naphthalene dicarboxylate, and polybutylene terephthalate.

A representative example of the polyolefin is polypropylene in particular, and copolymerized polypropylene is preferred in terms of stretchability. The copolymerized polypropylene is typically an ethylene copolymer, and a random copolymer or a block copolymer can be used. However, the random copolymer is preferred in terms of surface properties of the release surface. If necessary, an antioxidant, an antistatic agent, a colorant, a plasticizer, another resin, or the like can be added. The other layer materials and configurations can be the same as those in the first embodiment.

FIG. 6 is a schematic cross-sectional view of a pressure-sensitive adhesive label 1 according to a fifth embodiment of the present invention. The fifth embodiment is different from the first embodiment in that a release layer 8 is placed on the surface of the function layer 4, but is the same as the first embodiment in the other configurations. Therefore, the different point is mainly described below. Like reference symbols denote like parts or parts having like functions.

As illustrated in FIG. 6, the pressure-sensitive adhesive label 1 includes the recording paper 2, the pressure-sensitive adhesive layer 3, the function layer 4, and the release layer 8. The release layer 8 contains a release agent, and is provided for preventing sticking. The release layer 8 may be formed on the entire surface of the underlying function layer 4, or may be formed on a necessary part of the surface thereof. The release layer 8 may be formed by adding a release agent in a resin, or may be formed by dissolving or dispersing a release agent in a solvent and coating the underlying function layer 4 with the dispersion liquid, followed by drying. The release layer 8 is formed to have a smooth surface so as to ensure running performance of the pressure-sensitive adhesive label 1.

For the release layer 8, for example, a release agent made of one or at least two kinds selected from the group consisting of a silicone compound, a fluorine-based compound, a wax-based release agent, and an activator-based release agent, or a silicone phosphate ester can be used. Available examples of the wax-based release agent include a release agent whose main component is a mixture of petroleum, plant, and oily substances that are to be dissolved, emulsified, or suspended in water. The main component as used herein means that the weight ratio of the petroleum, plant, or oily substance in the mixture is 50 wt % or more, preferably 60 wt % or more.

As the release agent, solid waxes, fluorine-based or phosphate ester-based surfactants, or silicone oils can be used. Available examples of the solid wax include polyethylene wax, amide wax, and tetrafluoroethylene powder. As the silicone oil, an oily type can be used but a curable type is preferred. Examples of the curable silicone oil include reaction-curable, photocurable, catalyst-curable silicone oils, and the reaction-curable silicone oils are particularly preferred. In the case where such curable silicone oils are used as the release agent, as compared to the case where the above-mentioned surfactant-based release agent is used, the film surface can be avoided from being sticky or dust can be prevented from adhering thereon. The rough additive amount of the curable silicone oils in the resin is 0.5 wt % to 40 wt % with respect to the resin weight. When the additive amount is less than 0.5 wt %, a sufficient releasing effect cannot be obtained. When the additive amount is more than 40 wt %, the sensitivity of the opening mechanism may be reduced. The reaction-curable silicone oil is preferably obtained in a manner that an amino-modified silicone oil and an epoxy-modified silicone oil are reacted and cured. In the case where the release layer 8 is formed by coating, the thickness of the release layer 8 is set to be 0.005 μm to 3 μm, preferably 0.01 μm to 1 μm. When the thickness of the release layer 8 is less than 0.005 μm, a sufficient releasing effect cannot be obtained. When the thickness of the release layer 8 is more than 3 μm, the opening sensitivity of the film is reduced, which is not preferred. In other words, in order to prevent the sticking by forming the release agent on the heat generating part of the thermal head, it is necessary to form the release agent to be thick in consideration of abrasion by the pressure-sensitive adhesive label 1, but, when the release agent is formed to be thick, the heat conductivity is reduced to hinder the opening of the function layer 4. On the other hand, by forming the release layer 8 on the pressure-sensitive adhesive label 1 side as in the present invention, the release layer 8 can be formed extremely thin, which eliminates the factor of hindering the opening of the function layer 4.

The formation of the release layer 8 is not limited to a specific method. For example, the release layer 8 may be formed in a manner that a component containing a release agent is dispersed or dissolved in an arbitrary solvent at a concentration of 1 wt % or less, followed by coating with the use of a roll coater, a gravure coater, a micro gravure coater, a reverse coater, a bar coater, or the like and then evaporating the solvent. The coating amount of the release layer 8 is set to be 0.001 g/m² to 0.5 g/m², preferably about 0.01 g/m² to about 0.05 g/m², in order not to hinder the mechanism of forming the opening by thermal fusion of the film using the thermal head and to obtain sufficient release properties.

The coating of the release agent may be performed at any stage before and after stretching of a film serving as an underlying layer. As a method of controlling the wettability of the underlying film at the time of the coating of the release agent, a silane coupling agent may be used to excite a functional group of the coated surface, or corona discharge treatment may be performed on the coated surface. Note that, the release layer 8 according to the present invention is excellent in environmental resistance, and hence the roll can be kept in better conditions to maintain the quality of the pressure-sensitive adhesive label 1 for a long period of time. Further, the release layer 8 may contain a binder resin, a thermofusible resin, or the like as appropriate as long as the object of the present invention is not hindered. For example, a heat-resistance material, an antioxidant, a surfactant, an antiseptic, a defoamant, or the like may be added.

A description has been given above of the pressure-sensitive adhesive label 1 of the present invention by way of the first to fifth embodiments. By containing an antistatic agent in any of the layers, the charging of the pressure-sensitive adhesive label 1 by static electricity can be prevented. A specific description is given below.

It is preferred that any one of the recording paper 2, the pressure-sensitive adhesive layer 3, the function layer 4, and the release layer 8 contain an antistatic agent. Containing the antistatic agent can prevent a conveyance failure of the pressure-sensitive adhesive label 1. As the antistatic agent, for example, a glycerol mono fatty acid ester can be used. The antistatic agent is blended in any one of the above-mentioned layers or is applied onto the surface thereof. As the application method, for example, an antistatic agent is diluted by a solvent such as water or an alcohol solution, followed by coating with the use of a spray, an immersion, a brush, a roll coater, or the like and thereafter drying. The content amount or the application amount of the antistatic agent is not particularly limited, and can be arbitrarily set as long as the antistatic function can be exerted and the opening 13 can be formed in the function layer 4 by using the thermal head. Containing the antistatic agent can prevent the function layer 4 from being opened by discharge when the pressure-sensitive adhesive label 1 adheres to a hand.

Note that, although the thermal head 15 is used in the first embodiment as the heating means for heating the function layer 4 of the pressure-sensitive adhesive label 1 to be opened, the pressure-sensitive adhesive label 1 according to the present invention is not limited to this heating means. For example, the function layer 4 may be opened by heating by an electromagnetic wave such as a laser or a microwave. Even in the case of using the electromagnetic wave to open the function layer 4, because the release layer 8 is placed on the uppermost part of the pressure-sensitive adhesive label 1, the paper feeding performance of the pressure-sensitive adhesive label 1 can be improved to suppress the contamination of the label issuing device and the pressure-sensitive adhesive label 1. Further, as the thermal head, a line thermal head or a serial thermal head can be used. Further, a resistor of the heating part of the thermal head may be a thin film thermal head or may be a thick film thermal head formed by thick film printing.

As described above, the pressure-sensitive adhesive label 1 according to the present invention uses no release paper. Consequently, an environmental load can be reduced because no release paper is discarded when the pressure-sensitive adhesive label 1 is used. Further, the thickness is reduced because of no release paper, and hence the number of effective pressure-sensitive adhesive labels to be issued per roll can be increased. In addition, a material having small stiffness is used for the base of the recording paper 2, and hence, when the function layer 4 is opened and a pressure is applied from the recording paper 2 side, the contact area between the pressure-sensitive adhesive layer 3 and the adherend 12 is enlarged so that desired adhesive force can be ensured. In addition, the smoothness of the pressure-sensitive adhesive surface of the pressure-sensitive adhesive layer 3 is set to be higher than the smoothness of the surface of the recording paper supporting the pressure-sensitive adhesive layer 3, to thereby increase the contact area of the pressure-sensitive adhesive layer 3 with respect to the adherend 12, with the result that the pressure-sensitive adhesive force can be improved. Further, the pressure-sensitive adhesive label 1 in which the smoothness of the pressure-sensitive adhesive surface of the pressure-sensitive adhesive layer 3 is high is manufactured by a manufacturing method to be described below, to thereby prevent unintended color development or discoloring of the recording surface.

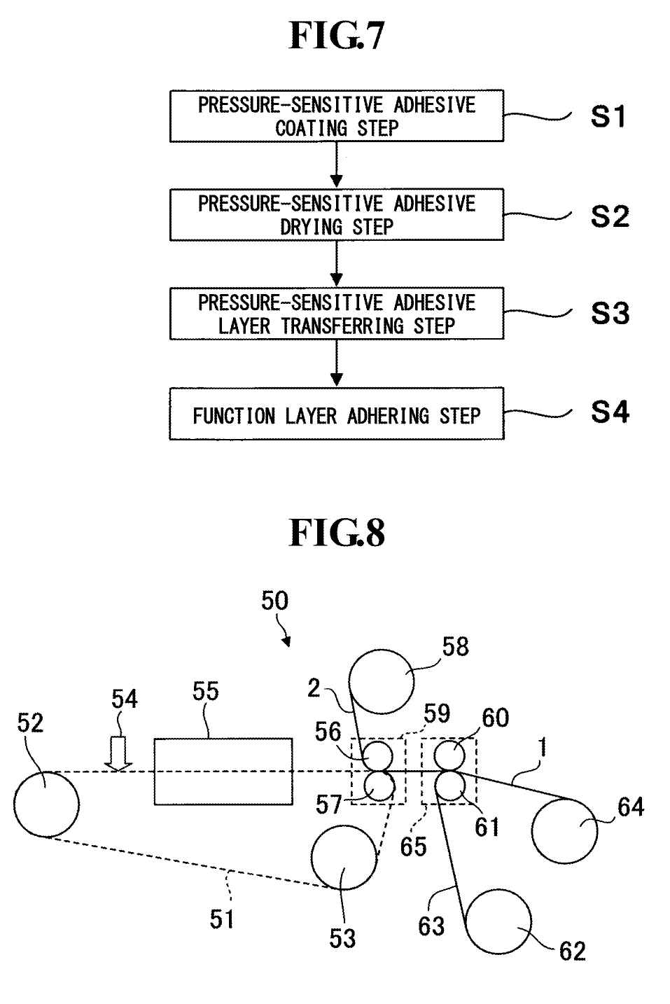

FIG. 7 is a flowchart illustrating a method of manufacturing a pressure-sensitive adhesive label 1 according to a sixth embodiment of the present invention. In the following description, like reference symbols denote like parts or parts having like functions.

A method of manufacturing the pressure-sensitive adhesive label 1 according to the present invention includes a pressure-sensitive adhesive coating step S1 for coating a pressure-sensitive adhesive, a pressure-sensitive adhesive drying step S2 for drying the pressure-sensitive adhesive, a pressure-sensitive adhesive layer transferring step S3 for transferring the pressure-sensitive adhesive layer onto the recording paper 2, and a function layer adhering step S4 for adhering the function layer 4 onto the pressure-sensitive adhesive layer 3. In the pressure-sensitive adhesive coating step S1, a support member having a smooth surface is coated with a pressure-sensitive adhesive. In the pressure-sensitive adhesive drying step S2, the pressure-sensitive adhesive coated on the support member is dried and thickened to form a pressure-sensitive adhesive layer. In the pressure-sensitive adhesive layer transferring step S3, the pressure-sensitive adhesive layer is transferred onto a rear surface of the recording paper 2 on the opposite side of a recording surface thereof. In this manner, the surface of the pressure-sensitive adhesive layer 3 can be finished to a smoother surface than the rear surface of the recording paper 2. In the function layer adhering step S4, the function layer 4 is adhered onto the pressure-sensitive adhesive layer 3 transferred onto the recording paper 2.

As described above, the recording paper 2 is transferred after the pressure-sensitive adhesive layer is dried to volatilize a solvent, and hence unintended color development or discoloring of the recording layer of the recording paper 2 can be prevented. Further, the surface of the pressure-sensitive adhesive layer 3 on the function layer 4 side is smooth, and hence the pressure-sensitive adhesive force when the function layer 4 is opened can be enhanced, and the fluctuations in pressure-sensitive adhesive force can be reduced.

FIG. 8 is a schematic structural view of a pressure-sensitive adhesive label manufacturing device 50 for manufacturing the pressure-sensitive adhesive label 1 according to a seventh embodiment of the present invention. The pressure-sensitive adhesive label manufacturing device 50 according to the present invention includes pressure-sensitive adhesive coating means 54 for coating a surface of a support member with a pressure-sensitive adhesive, pressure-sensitive adhesive drying means 55 for drying the pressure-sensitive adhesive to form a pressure-sensitive adhesive layer, pressure-sensitive adhesive layer transferring means 59 for transferring the pressure-sensitive adhesive layer onto the recording paper 2, and function layer adhering means 65 for adhering a function layer onto the pressure-sensitive adhesive layer. A specific description is given below.

An endless belt 51 functions as the support member for coating the pressure-sensitive adhesive. The endless belt 51 can be formed from a synthetic resin or a metal film whose surface has a higher smoothness than that of the rear surface of the recording paper 2. As the endless belt 51, for example, a synthetic resin such as polyethylene terephthalate (PET) or a polyolefin resin can be used. Further, paper or various kinds of materials may be laminated on the synthetic resin. The endless belt 51 may be formed by adhering or coating a heat-resistant synthetic resin onto a belt with sufficient strength such as a metal or a rubber or onto ground fabric of a heat-resistant fiber. Further, a silicone resin can be used as a release layer (peeling layer) of the endless belt 51. The types of silicone resin include an addition type and a condensed type, and the condensed type is preferred because of its superior durability. The endless belt 51 that uses a condensed type silicone resin is superior in durability as the support member for the pressure-sensitive adhesive because the degradation in release property (peeling property) is significantly low. A release surface (peeling surface; surface for mounting the pressure-sensitive adhesive thereon) of the endless belt 51 is reflected on the surface of the pressure-sensitive adhesive layer. Therefore, it is desired that the release surface (peeling surface) be a mirrored surface.

The endless belt 51 is stretched over a roller 52, a conveying roller 57, and a roller 53, and circulates therearound. First, the pressure-sensitive adhesive coating means 54 coats a smooth surface of the endless belt 51 serving as the support member with a pressure-sensitive adhesive (pressure-sensitive adhesive coating step S1). As the pressure-sensitive adhesive coating means 54, for example, a roll coater, a knife coater, a bar coater, a slot die coater, a curtain coater, a gravure coater, a micro gravure coater, or the like can be used. Next, the pressure-sensitive adhesive drying means 55 dries and thickens the pressure-sensitive adhesive coated onto the endless belt 51 to form a pressure-sensitive adhesive layer (pressure-sensitive adhesive drying step S2). In the pressure-sensitive adhesive drying means 55, a heating part and a ventilation part are placed to dry the pressure-sensitive adhesive on the endless belt 51 in a short period of time.

The recording paper 2 is pulled out from a recording paper roll-up roller 58. The recording paper 2 and the endless belt 51 are sandwiched between conveying roller 56 and 57 serving as the pressure-sensitive adhesive layer transferring means 59, and the pressure-sensitive adhesive layer 3 is transferred onto the rear surface of the recording paper 2 on the opposite side of the recording surface. In this case, the surface of the pressure-sensitive adhesive layer 3 (surface opposite to the recording paper 2 side) is finished to a smoother surface than the rear surface of the recording paper 2 (pressure-sensitive adhesive layer transferring step S3). Next, a function film 63 is pulled out from a function film roll-up roller 62. The recording paper 2 having the pressure-sensitive adhesive layer 3 transferred thereon and the function film 63 are sandwiched between conveying rollers 60 and 61 serving as the function layer adhering means 65, and the function film 63 is adhered onto the pressure-sensitive adhesive layer 3 to form the function layer 4 (function layer adhering step S4). The pressure-sensitive adhesive label 1 including the recording paper 2, the pressure-sensitive adhesive layer 3, and the function layer 4 are rolled by a pressure-sensitive adhesive label roll-up roller 64.

As described above, before the pressure-sensitive adhesive layer 3 is transferred onto the recording paper 2, a solvent contained in the pressure-sensitive adhesive is volatilized by the pressure-sensitive adhesive drying means 55. Consequently, the solvent is prevented from penetrating to the recording layer after the pressure-sensitive adhesive layer 3 is transferred onto the recording paper 2, and the unintended color development or discoloring of the recording layer is prevented. Further, the surface of the pressure-sensitive adhesive layer 3 on the function layer 4 side can be set to have a higher smoothness than that of the rear surface of the recording paper 2, and hence the pressure-sensitive adhesive force when the function layer 4 is opened can be enhanced, and the fluctuations in pressure-sensitive adhesive force can be reduced. Further, the circulating endless belt 51 is used as the support member for coating the pressure-sensitive adhesive, and hence a wasted support member is not generated in the manufacturing of the pressure-sensitive adhesive label 1, and an environmental load is reduced. Note that, the step of forming the function layer 4 as a double layer or the step of forming a release layer 8 on the surface of the function layer 4 can be easily added to the above-mentioned device.

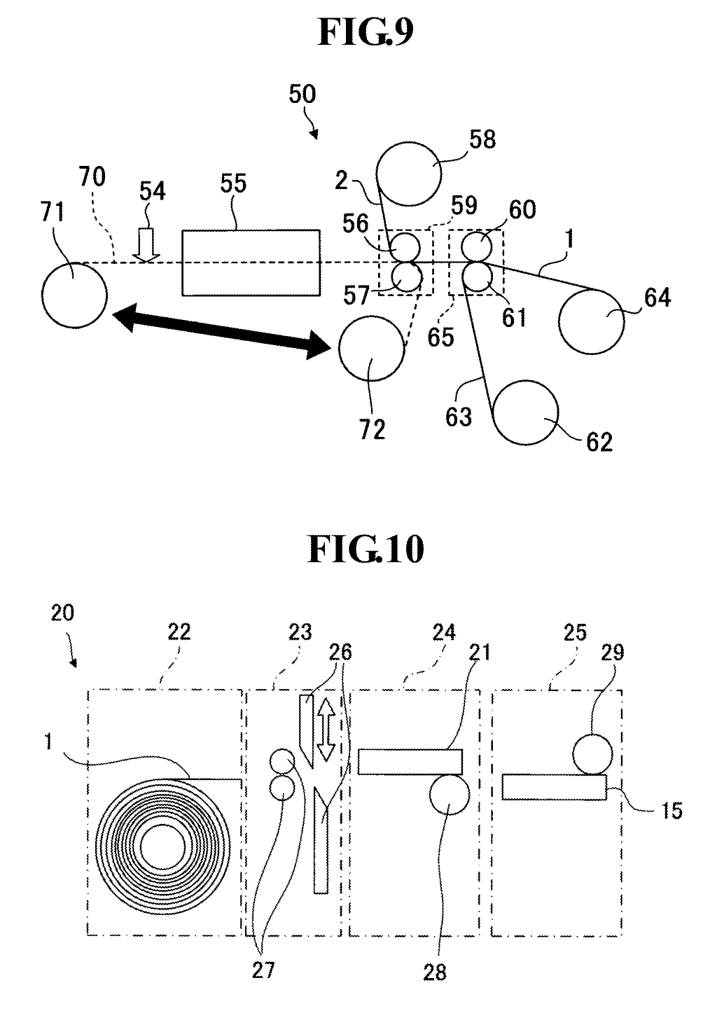

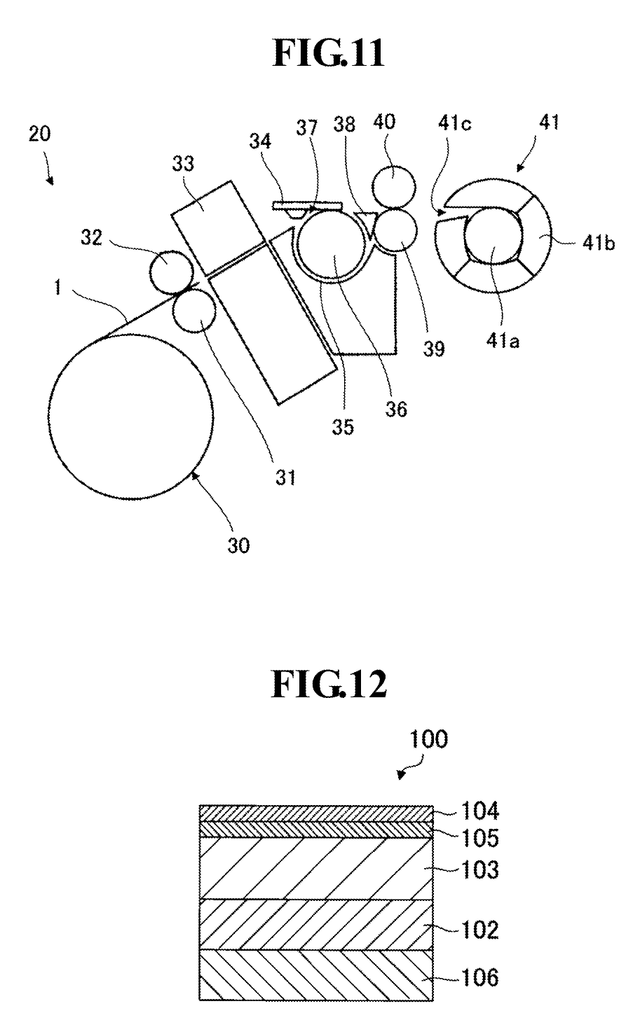

FIG. 9 is a schematic structural view of a pressure-sensitive adhesive label manufacturing device 50 for manufacturing the pressure-sensitive adhesive label 1 according to an eighth embodiment of the present invention. The eighth embodiment is different from the seventh embodiment in employing a roll-up type that uses an open end belt 70 instead of the endless belt 51. Therefore, the different point is mainly described below. Like reference symbols denote like parts or parts having like functions.

The open end belt 70 functions as the support member for coating the pressure-sensitive adhesive similarly to the endless belt 51 of the above-mentioned seventh embodiment. The open end belt 70 is stretched between an open end belt feed roller 71 and an open end belt roll-up roller 72 via the roller 57, and is rolled by the open end belt roll-up roller 72. Then, when the roll-up of the open end belt 70 is finished, as indicated by black arrows of FIG. 9, the roller 71 and the roller 72 are interchanged to restart the feed of the open end belt 70. By repeating this operation, similarly to the above-mentioned seventh embodiment, a wasted support member is not generated in the manufacturing of the pressure-sensitive adhesive label 1, and an environmental load is reduced.

A release film to be used as the above-mentioned endless belt 51 and open end belt 70 is used for the purpose of maintaining the uniformity and stabilization of products and protecting the product from dirt and flaw at a time of storage. The release film is used in a wide field including a manufacturing process and transfer printing for a circuit board, a ceramic, and an adhesive film, for example. Further, this type of release film is selected from specifications determined based on a film base having release properties. Examples of the film include a PET film in which silicone is laminated, a fluorine resin film, and a polyolefin resin film. However, those films have the following problems. Silicone has a risk of contamination on an adherend by a low molecular weight of silicone. The fluorine resin film is expensive and has a risk of generation of a harmful gas at a time of incineration. The polyolefin resin film is inferior in heat resistance.

To deal with this, a material satisfying the following three conditions is employed for the above-mentioned endless belt 51 and open end belt 70 in consideration of those problems and the ability that initial characteristics can be maintained under continuous use. First, peeling force of the endless belt 51 and the open end belt 70 is set to achieve light peeling. The grade of the peeling force is defined so that the peeling force of 30 mN/25 mm or less is for light peeling, the peeling force of 50 to 100 mN/25 mm is for medium peeling, and the peeling force of 100 mN/25 mm or more is for heavy peeling. Then, secondly, the residual adhesion rate of the endless belt 51 and the open end belt 70 is set to 80% or more, desirably 90% or more. The residual adhesion rate is used as an index for evaluating silicone transfer. As the residual adhesion rate approaches 100%, the silicone transfer becomes lower. Then, thirdly, the surface roughness of the pressure-sensitive adhesive coating surface of the endless belt 51 and the open end belt 70 is set to 1.2 μm or less, desirably 0.3 μm to 1.2 μm. The flatness of the function layer 4 to be brought into contact with the thermal head 15 affects the surface state of the pressure-sensitive adhesive layer 3, and the flatness leads to stabilization of the heating conditions of the thermal head 15. Therefore, by setting the surface roughness of the pressure-sensitive adhesive coating surface of the endless belt 51 and the open end belt 70 in the above-mentioned range, the opening property (perforation property) of the function layer 4 under a heated state can be improved.

A label issuing device according to the present invention includes a conveying part for conveying the pressure-sensitive adhesive label according to the first to fifth embodiments, a heating part for heating the function layer to form an opening to expose the pressure-sensitive adhesive layer, and a control part for controlling the conveying part and the heating part.

The label issuing device of the present invention can set a pressure-sensitive adhesive region and a non-pressure-sensitive adhesive region immediately before the use of the pressure-sensitive adhesive label in accordance with the purpose of use without using a large-scale production device. Further, the number, positions, and aperture ratio of openings to be formed in the pressure-sensitive adhesive region can be changed in accordance with the properties of an adherend and the use environment of the pressure-sensitive adhesive label. In addition, release paper is not required to be used, and the pressure-sensitive adhesive label can be reduced in thickness due to the absence of release paper so that the number of issuance of effective pressure-sensitive adhesive labels per roll can be increased. Further, an environmental load can be reduced due to the absence of release paper. In addition, by providing the release layer as the uppermost layer of the pressure-sensitive adhesive label, the pressure-sensitive adhesive label can be prevented from adhering onto the heating part, that is, the sticking can be prevented, and hence the pressure-sensitive adhesive region can be accurately formed at an intended position of the pressure-sensitive adhesive label. Besides, the contamination of the label issuing device caused by the adhesion of the pressure-sensitive adhesive label onto the device can also be prevented.

A specific description is given. As the heating part, a thermal head or laser light can be used. When the thermal head is used, a large number of heat generating elements can be arranged in a row, and hence, a large number of openings can be formed in the function layer simultaneously in a row. The control part selects opening pattern information stored in advance and causes the heat generating element to generate heat to form a pressure-sensitive adhesive region including a plurality of openings in the function layer. The control part controls the conveying part to convey the pressure-sensitive adhesive label 1 in a predetermined amount and causes the heat generating element to generate heat. By repeating this process, a predetermined opening pattern in which the pressure-sensitive adhesive layer is exposed is formed in the pressure-sensitive adhesive label.

An opening diameter of the opening can be controlled in accordance with the heat quantity applied by the heat generating element. That is, in order to decrease an opening diameter, the heat quantity applied from the heat generating element to the function layer is suppressed, and in order to increase an opening diameter, the heat quantity is increased. That is, the control part can control an opening diameter of the opening by controlling power supplied to the heat generating element and heating time for heating the function layer. The pattern information of the opening is stored in advance, and the control part controls the heating part and the conveying part based on the pattern information of a selected opening pattern to form a pressure-sensitive adhesive region formed of the pattern of the opening in the pressure-sensitive adhesive label. For example, an opening pattern in which a plurality of openings are arranged in vertical and horizontal directions, an opening pattern in which openings are arranged in a zigzag shape, an opening pattern in which openings are arranged in a honeycomb shape, or an opening pattern including a plurality of different openings can be selected to be formed. Ninth and tenth embodiments of the present invention are described in detail below.

FIG. 9 is a schematic structural view of a label issuing device 20 according to ninth embodiment of the present invention. The label issuing device 20 includes a roll sheet accommodating part 22 for accommodating the pressure-sensitive adhesive label 1, a roll sheet cutting part 23 for cutting the pressure-sensitive adhesive label 1, a label recording part 24 as a recording part for performing recording on the pressure-sensitive adhesive label 1, and a pressure-sensitive adhesiveness expressing part 25 for allowing the pressure-sensitive adhesive label 1 to express pressure-sensitive adhesiveness. The roll sheet accommodating part 22 accommodates the pressure-sensitive adhesive label 1 rolled into a roll shape. As illustrated in FIG. 1, for example, the pressure-sensitive adhesive label 1 has a laminate structure including the recording paper 2, the pressure-sensitive adhesive layer 3, and the function layer 4. Alternatively, as illustrated in FIG. 9, the pressure-sensitive adhesive label 1 has a laminate structure including the recording paper 2, the pressure-sensitive adhesive layer 3, and the function layer 4. The roll sheet cutting part 23 cuts the pressure-sensitive adhesive label 1 sent from conveying rollers 27 as the conveying part to a predetermined length by a cutter member 26. The label recording part 24 records information by a recording thermal head 21 on the recording surface (of the thermosensitive recording layer) of the pressure-sensitive adhesive label 1 placed on a conveying roller 28. As already described with reference to FIG. 2, the pressure-sensitive adhesiveness expressing part 25 heats and opens the function layer 4 of the pressure-sensitive adhesive label 1, which is sandwiched between a conveying roller 29 as the conveying part and the thermal head 15, by the thermal head 15 as the heating part to expose the pressure-sensitive adhesive layer 3 through the opening 13.

Here, the thermal head 15 is provided with the heat generating part in which a plurality of heat generating bodies are arranged in parallel, and thus, can form the pressure-sensitive adhesive region in which a plurality of openings 13 are opened in parallel simultaneously. It is preferred that a heat-concentration type head be used as the heat generating part. The heat generating surface of the heat generating part may have any shape such as a rectangle, a circle, an oval, a heart-like shape, or other shapes. A plurality of heat generating bodies can be formed at an arrangement density of 100 dpi to 600 dpi.

The label issuing device 20 can form the pressure-sensitive adhesive region including a plurality of openings 13 in a conveying direction of the pressure-sensitive adhesive label 1 by using the control part (not shown) to control the heating part and the conveying part. That is, the label issuing device 20 can form a required number of openings 13 at positions required in the pressure-sensitive adhesive label 1. In this manner, it is possible to control the position and size of the pressure-sensitive adhesive region in which pressure-sensitive adhesiveness of the pressure-sensitive adhesive label 1 is to be expressed.

FIG. 10 is a schematic structural view of a label issuing device 20 according to a tenth embodiment of the present invention. The tenth embodiment is different from the ninth embodiment in that one thermal head 34 records a character and the like on the thermosensitive recording layer 8 and forms the opening 13 in the function layer 4. Like reference symbols denote like parts or parts having like functions.

The label issuing device 20 includes a roll accommodating unit 30 for accommodating the pressure-sensitive adhesive label 1 rolled into a roll shape, a cutter unit 33 for cutting the pressure-sensitive adhesive label 1, the thermal head 34 as the heating part for recording information on the thermosensitive recording layer of the pressure-sensitive adhesive label 1 and forming the opening 13 in the function layer 4, a platen roller 36 for holding the pressure-sensitive adhesive label 1 at a time of recording or forming of the openings 13 by the thermal head 34, a roll-up device 41 for rolling up the pressure-sensitive adhesive label 1 onto a roll-up roller 41a and retaining the pressure-sensitive adhesive label 1 temporarily, conveying rollers 31, 39 and driven rollers 32, 40 as the conveying part for conveying the pressure-sensitive adhesive label 1, conveying direction regulating means 38 for regulating a conveying direction of the pressure-sensitive adhesive label 1, and a control part (not shown) for controlling energy imparted to the thermal head 34 and controlling the rotation of the conveying rollers 31, 39 and the platen roller 36.

The label issuing device 20 operates as follows. The control part drives the conveying roller 31 and the driven roller 32 to pull out the rolled-up pressure-sensitive adhesive label 1 in the roll accommodating unit 30. The control part further delivers the pressure-sensitive adhesive label 1 having passed through the cutter unit 33 from a delivery path 37 and rotates the platen roller 36 in a clockwise direction so that the pressure-sensitive adhesive label 1 is sandwiched between the platen roller 36 and the thermal head 34. The control part further causes the heat generating part of the thermal head 34 to generate heat and record printing information on the recording surface of the pressure-sensitive adhesive label 1. The control part rotates the conveying roller 39 and the roll-up roller 41a to guide the pressure-sensitive adhesive label 1 having the recorded recording surface from an insertion port 41c into the roll-up device 41, and rolls up the pressure-sensitive adhesive label 1 while pressing the pressure-sensitive adhesive label 1 onto the roll-up roller 41a with a guide 41b. The control part operates the cutter unit 33 to cut the pressure-sensitive adhesive label 1, to thus complete a recording operation.

Next, the control part rotates the conveying roller 39 to convey the cut portion of the pressure-sensitive adhesive label 1 to the position of the conveying roller 39 and the driven roller 40. Next, the control part drives the conveying direction regulating means 38 to rotate the conveying roller 39 in a reverse direction and rotate the platen roller 36 in a clockwise direction, and inverts the pressure-sensitive adhesive label 1 through a conveying path 35 to sandwich the pressure-sensitive adhesive label 1 between the thermal head 34 and the platen roller 36. The control part causes the heat generating part of the thermal head 34 to generate heat based on the selected pattern information and forms a predetermined pressure-sensitive adhesive region including a plurality of openings 13 in the function layer 4 of the pressure-sensitive adhesive label 1. The pressure-sensitive adhesive label 1 in which the pressure-sensitive adhesive region is formed is pulled out from the position of the conveying direction regulating means 38 to the outside.

The shape and the like of the pressure-sensitive adhesive region can be formed by selecting an opening pattern in which the plurality of openings 13 are arranged in vertical and horizontal directions, an opening pattern in which the openings 13 are arranged in a zigzag shape, an opening pattern in which the openings 13 are arranged in a honeycomb shape, an opening pattern including a plurality of different openings 13, or other such opening pattern. Thus, the pressure-sensitive adhesive region and the non-pressure-sensitive adhesive region can be set immediately before the use of the pressure-sensitive adhesive label 1 in accordance with the purpose of use, and further, the number, positions, and aperture ratio of the openings 13 to be formed in the pressure-sensitive adhesive region can be changed in accordance with the properties of the adherend 12 and the use environment of the pressure-sensitive adhesive label 1.

What is claimed is:

1. A pressure-sensitive adhesive label comprising:
recording paper including a recording surface;
a pressure-sensitive adhesive layer placed on a rear surface of the recording paper on an opposite side of the recording surface; and
a function layer placed on the pressure-sensitive adhesive layer,
wherein a surface of the pressure-sensitive adhesive layer on the function layer side has a smoother surface than the rear surface of the recording paper, and
the function layer is configured to be opened by heating to expose the pressure-sensitive adhesive layer.

2. A pressure-sensitive adhesive label according to claim 1, wherein
the surface of the pressure-sensitive adhesive layer on the function layer side has a surface roughness in a range of from 0.3 μm to 1.2 μm.

3. A pressure-sensitive adhesive label according to claim 1, wherein
the function layer has an average layer thickness in a range of from 0.1 μm to 10 μm.

4. A pressure-sensitive adhesive label according to claim 1, wherein
the function layer is formed of an olefin-based resin.

5. A pressure-sensitive adhesive label according to claim 1, wherein
the function layer is formed of a porous layer.

6. A pressure-sensitive adhesive label according to claim 5, wherein
the porous layer has a void content in a range of from 30% to 85%.

7. A pressure-sensitive adhesive label according to claim 1, wherein
the function layer is formed by laminating a first thermoplastic resin and a second thermoplastic resin, which are incompatible to each other.

8. A pressure-sensitive adhesive label according to claim 1, wherein
an opening formed by heating the function layer has a diameter of 40 μm or more.

9. A pressure-sensitive adhesive label according to claim 1, wherein
a release layer is placed on the function layer.

10. A pressure-sensitive adhesive label according to claim 1, wherein
the recording paper includes, at least on the recording surface, a thermosensitive recording layer on which recording is performed by heating.

11. A method of manufacturing a pressure-sensitive adhesive label including:
coating a smooth surface of a support member with a pressure-sensitive adhesive;
drying the pressure-sensitive adhesive to form a pressure-sensitive adhesive layer;
transferring the pressure-sensitive adhesive layer onto a rear surface of recording paper on an opposite side of a recording surface thereof, and finishing a surface of the pressure-sensitive adhesive layer to a smoother surface than the rear surface of the recording paper; and
adhering a function layer onto the pressure-sensitive adhesive layer.

12. A method of manufacturing a pressure-sensitive adhesive label according to claim 11, wherein
the support member is formed of an endless belt having a smooth surface.

13. A pressure-sensitive adhesive label manufacturing device comprising:
pressure-sensitive adhesive coating means for coating a surface of a support member with a pressure-sensitive adhesive;
pressure-sensitive adhesive drying means for drying the coated pressure-sensitive adhesive to form a pressure-sensitive adhesive layer;
pressure-sensitive adhesive layer transferring means for transferring the pressure-sensitive adhesive layer onto recording paper; and
function layer adhering means for adhering a function layer onto the pressure-sensitive adhesive layer.

14. A pressure-sensitive adhesive label manufacturing device according to claim 13, wherein
the support member is formed of an endless belt having a smooth surface.

15. A label issuing device comprising:
a conveying part for conveying the pressure-sensitive adhesive label according to claim 1;
a heating part for heating the function layer to form an opening to expose the pressure-sensitive adhesive layer; and
a control part for controlling the conveying part and the heating part.

16. A label issuing device according to claim 18, further comprising:
a recording part for heating the recording surface of the pressure-sensitive adhesive label.
